(19) United States
(12) Patent Application Publication
(10) Pub. No.: US 2010/0238585 A1
(43) Pub. Date: Sep. 23, 2010

(54) METHOD OF CONTROLLING FLYING HEIGHT OF MAGNETIC HEAD OF HARD DISK DRIVE

(75) Inventor: Ji Hoon Kang, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/724,444

(22) Filed: Mar. 16, 2010

(30) Foreign Application Priority Data
Mar. 17, 2009 (KR) 10-2009-0022406

(51) Int. Cl. G11B 21/02

(52) U.S. Cl. 360/75; G9B/21.003

(57) ABSTRACT

A method of controlling an HDD includes acquiring a reference FOD voltage profile offering a correlation between flying heights FH of a magnetic head and FOD voltages that if applied to the magnetic head would cause the head to fly at the flying heights (FH) in an idealized situation, determining changes in the FH of the magnetic head during the rotation of the disk by analyzing magnetic signal output from the magnetic head at that time, producing an applied FOD voltage profile based on the changes in the FH of the magnetic head and the reference FOD voltage profile, and applying and FOD voltage to the magnetic head when a write command or a read command is issued in the HDD and at that time regulating the FOD voltage applied to the magnetic head based on the applied FOD voltage profile to maintain the FH of the magnetic head constant as the head tracks along the disk

### PRIORITY STATEMENT

This application claims the benefit of Korean Patent Application No. 10-2009-0022406 filed on 17 Mar., 2009, in the Korean Intellectual Property Office.

### BACKGROUND

The inventive concept relates to a method of controlling a hard disk drive (HDD). More particularly, the inventive concept relates to a method of controlling the flying height of a magnetic head of an HDD using flying on demand (FOD) technology, i.e., by regulating the FOD voltage of a hard disk drive.

Many of today's electronic devices use an HDD to store data. Not only must HDDs be small and compact to facilitate the downsizing of the electronic devices which employ them, but HDDs must also store greater and greater amounts of data to keep up with the demand for the devices to be more multi-functional, for example. To meet such demands, the recording density of the data storage disk of an HDD, i.e., a measure of tracks per inch (TPI) and bits per inch (BPI), is constantly being increased. Consequently, the magnetic head of an HDD which reads/writes data from/onto the disk must be controlled with higher degrees of precision. In particular, the flying height (FH) of the magnetic head, namely, the distance at which the magnetic head is floated over the disk during a read/write operation, must be controlled very precisely. In the case of a data storage disk having a high recording density this means that the FH of the magnetic head must be controlled to be as low as possible. In this respect, the flying height (FH) of the magnetic head can be controlled in real time through what is known as FOD (flying on demand) technology.

Meanwhile, the disk of the HDD is coupled to a spindle motor for rotating the disk during a read/write operation. However, the disk of the HDD is often deformed in its radial and circumferential directions when the disk is coupled to the spindle motor, due to the torque used to secure the disk to the motor and/or due to tolerances in the assemblage of the disk and the motor falling outside prescribed limits. With respect to the deformation in the radial direction, the recording surface of the disk gradually rises from the center of the disk toward the circumference thereof. With respect to the deformation in the circumferential direction, the surface of the disk undulates up and down.

Such deformation of the disk may affect the FH of the magnetic head. In particular, when deformation exists in the circumferential direction, the FH of the magnetic head may vibrate during a read/write operation, i.e., as the disk is rotating. Even if the FH of the magnetic head is designed to allow for such deformation of the disk, poor environmental conditions such as those created by high altitude or high temperatures can nonetheless further reduce the FH of the magnetic head. In an excessive case, the magnetic head can collide with the disk at a relatively high point in the deformed surface of the disk. That is, so-called head disk interference (HDI) can occur. Also, the magnetic head may produce weak write signals at an area of the disk where the FH of the magnetic head is relatively high relative to the recording surface due to the deformation of the disk. The above-described problems become particularly severe in an HDD employing FOD technology because the FH of the magnetic head is controlled to be as low as possible due to the high recording density.

### SUMMARY

According to an aspect of the inventive concept, there is provided a method of controlling the flying height of a magnetic head of a hard disk drive (HDD) to keep the flying height as constant as possible over one or more tracks of a disk of the HDD. A reference FOD voltage profile is acquired. The reference voltage profile offers a correlation between flying heights FH of the magnetic head and FOD voltages that if applied to the magnetic head would cause the head to fly at the flying heights (FH) in an idealized situation. Changes in the FH of the magnetic head during the rotation of the disk are determined by analyzing magnetic signal output from the magnetic head at that time. An applied FOD voltage profile, based on the changes in the FH of the magnetic head and the reference FOD voltage profile, is produced. When a write command or a read command is issued in the HDD an FOD voltage is applied to the magnetic head and the applied FOD voltage is regulated based on the applied FOD voltage profile to maintain the FH of the magnetic head constant as the head tracks along the disk.

### BRIEF DESCRIPTION OF THE DRAWINGS

The inventive concept will be more clearly understood from the following detailed description of the preferred embodiments thereof made in conjunction with the accompanying drawings in which:

FIG. 1 is a partially exploded perspective view of an HDD to which a method of controlling an FOD voltage according to the present inventive concept may be applied;

FIG. 2 is a plan view of a disk in the HDD of FIG. 1;

FIG. 3 is a graph showing the deformation in the radial direction of the disk of FIG. 2;

FIG. 4 is a graph showing the deformation in the circumferential direction of the disk of FIG. 2;

FIG. 5 is a block diagram of a control system of the HDD of FIG. 1;

FIG. 6 is a flowchart of a method of controlling an FOD voltage of an HDD according to the present inventive concept;

FIG. 7 is a flowchart detailing the operations S150 and S170 of the method shown in FIG. 6;

FIG. 8 is a graph showing an example of a reference FOD voltage profile calculated in the operation S110 of the method shown in FIG. 6;

FIG. 9 is a schematic diagram illustrating changes in the FH of the magnetic head in the operation S130 of the method shown in FIG. 6;

FIG. 10 is a graph showing an example of an applied FOD voltage profile calculated in the operation S150 of the method shown in FIG. 6;

FIG. 11 is a schematic diagram illustrating that the FH of the magnetic head is maintained constant along the circumferential direction of the disk in spite of the deformation of the disk according to the method shown in FIG. 6;

FIG. 12 is a flowchart of another embodiment of a method of controlling an FOD voltage of an HDD according to the present inventive concept; and

FIG. 13 is a flowchart detailing the operations 5250 and 5270 of the method shown in FIG. 12.

### DETAILED DESCRIPTION OF THE PREFERRED EMBODIMENTS

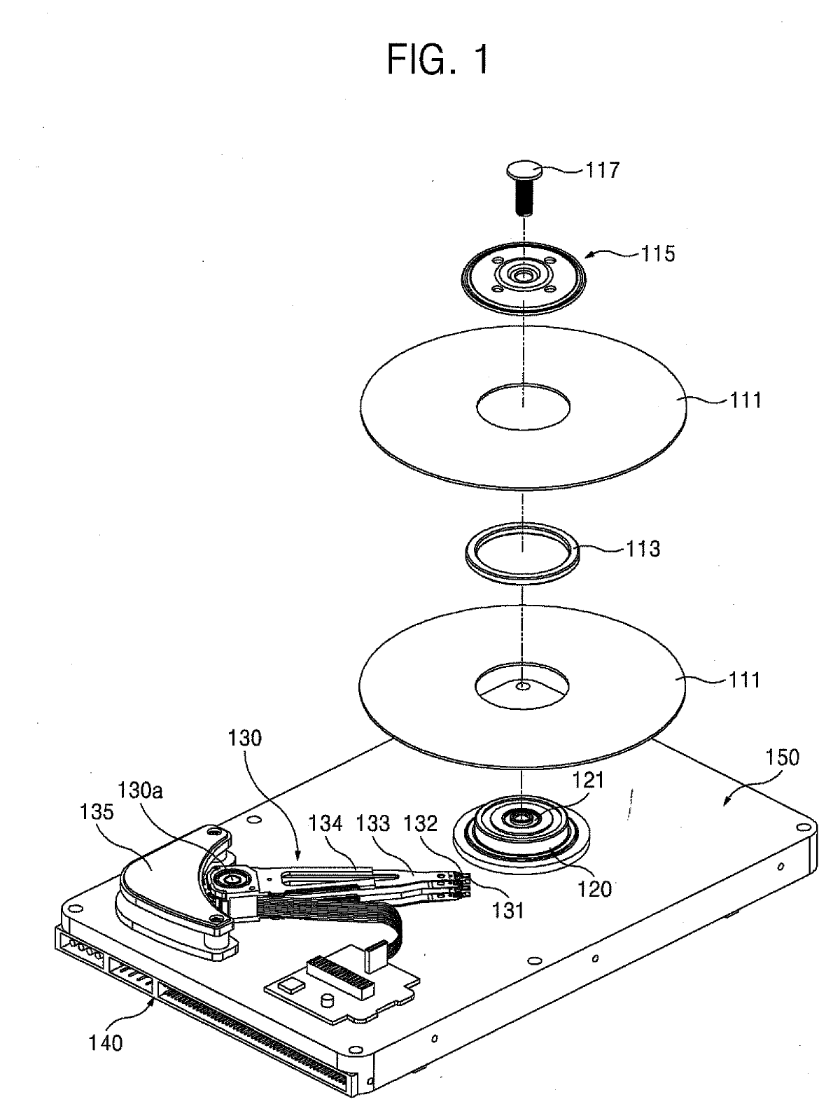

Embodiments of the inventive concept will be described in detail hereinafter with reference to the attached drawings. Like reference numerals denote like elements in the drawings. First, though, a hard disk drive (HDD) which may employ a method of controlling an FOD voltage according to the present inventive concept, will be described with reference to FIG. 1. The HDD includes at least one disk 111 for storing data, a spindle motor (SPM) 120 for rotating the disk(s) 111, a head stack assembly (HSA) 130 for recording data on the disks 111 or reproducing data from the disk(s) 111, a pivot shaft 130a supporting the HSA 130 so as to be rotatable about an axis thereof, a printed circuit board assembly (PCBA) 140 having a printed circuit board (PCB) and circuit parts for electrically controlling the HDD mounted to the PCB, a base 150 to which the above constituent elements are assembled, and a cover (not shown) covering the base 150.

In this example of an HDD, two disks 111 are vertically stacked on the SPM 120 as illustrated in FIG. 1. However, the present inventive concept may be employed by an HDD having only one disk or by an HDD having three or more disks. Thus, the illustrated HDD having two disks 111 is being used as an example for ease of description only.

The two disks 111 are disposed on a hub 121 of the SPM 120 and rotatably supported by the hub 121 as separated from each other by an annular spacer 113. The disks 111 are fixed to the hub 121 by a disk clamp 115 disposed against an inner circumferential surface of an upper one of the disks 111, and a clamping screw 117, as also illustrated in FIG. 1. The clamping screw 117 is threaded to the hub 121 and the head of the screw 117 is seated on the disk clamp 115 so as to provide the force or torque by which the clamp 115 fixes the disks 111 to the hub 121.

The HSA 130 includes a magnetic head 131 for recording data on a disk 111 or reproducing data from the disk 111, a slider 132 integrated with the magnetic head 131, a suspension 133 for elastically supporting the slider 132 and biasing the slider 132 toward a surface of the disk 111, an actuator arm 134 for supporting the suspension 133 and rotatably supported by the pivot shaft 130a, and a voice coil motor (VCM) 135 as an actuator for rotating the actuator arm 134 about the axis of the pivot shaft 130a. The rotation of the actuator arm 134 is controlled by the VCM 135 so as to position the magnetic head 131 over a desired portion, e.g., over a desired track, of the disk 111.

The magnetic head 131 records data on a disk 111 by magnetizing a surface of the disk 111 or reproduces data from the disk 111 by sensing a magnetic field generated by a magnetized surface of the disk 111. To this end, and although not specifically illustrated in the accompanying drawings, the magnetic head 131 actually consists of a write head to magnetize the disk 111 and a read head to sense the magnetic field of the disk 111.

In general, each disk has two recording surfaces, i.e., an upper surface and a lower surface, and two magnetic heads are provided for each disk. The two magnetic heads are supported so as to confront the recording surfaces of the disk, respectively. In the example of the HDD shown in FIG. 1, four magnetic heads are provided because the HDD has two disks 111. Each magnetic head is spaced across from a respective one of the surfaces of the disks 111.

In an HDD having the structure described above, the magnetic head 131 records data on a surface of the disk 111 or reproduces data from the surface of the disk 111 while flying at a predetermined height (FH) over the surface of the disk 111. That is, the FH of the magnetic head 131 signifies the gap between the magnetic head 131 and the surface of the disk 111 associated with the magnetic head 131. As mentioned above, the FH must be controlled precisely if the HDD is to operate properly and if head disk interference (HDI) is to be prevented. Moreover, flying on demand (FOD) technology is one of the most widely used technologies used to control the FH of the magnetic head 131.

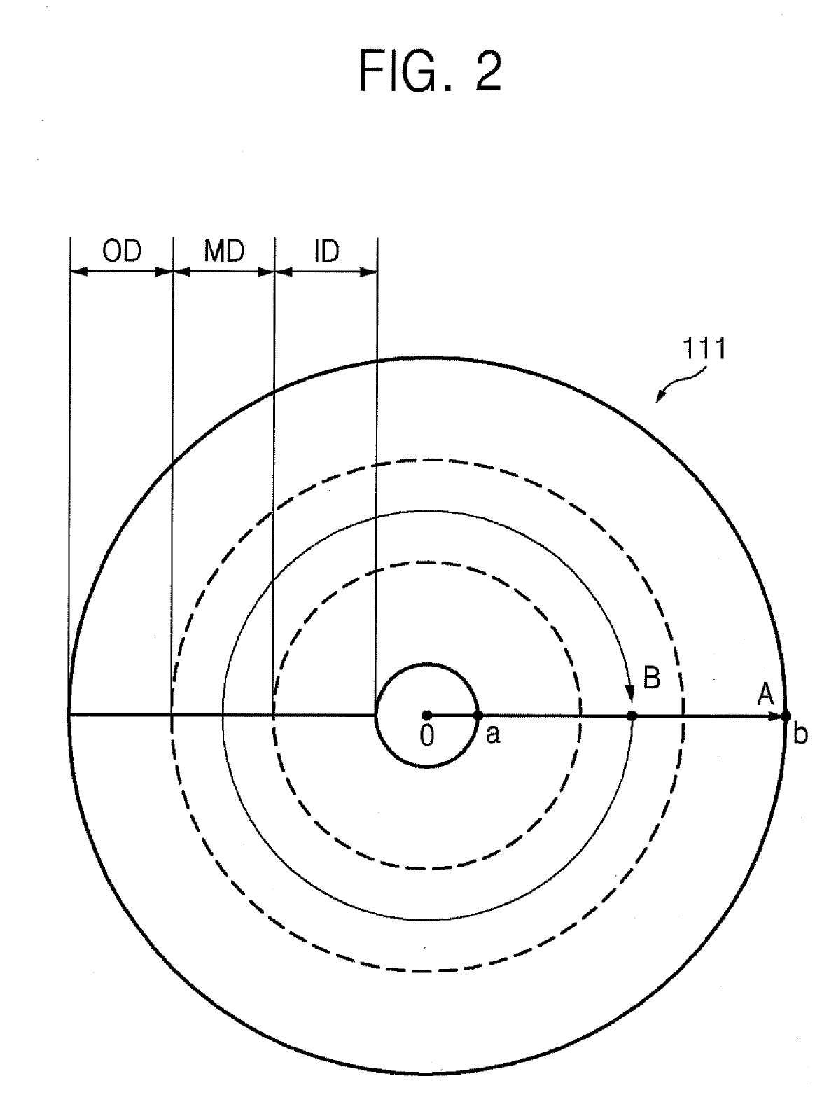

In FOD technology, a voltage or current (referred to merely as “FOD voltage” hereinafter) is applied to a heater integrated with the magnetic head 131. Thus, heat can be locally applied to the magnetic head 131 such that an end portion of the magnetic head 131 thermally expands. In this case, the expansion of the magnetic head 131 reduces the FH of the magnetic head 131. An embodiment of a method of controlling the FOD voltage of an HDD according to the present inventive concept will now be described with reference to FIGS. 2-11.

Referring first to FIG. 2, the disk 111 is sectioned off into an inner diameter (ID) region, a middle diameter (MD) region, and an outer diameter (OD) region in order of closeness to the center of the disk 111. Each of the regions consists of a plurality of circular tracks concentric to the center of the disk 111. Also, each track includes a plurality of sectors divided from one another by equal angular intervals with respect to the center of the disk 111. The sectors include servo and data sectors which are alternately disposed along the track. Each servo sector contains information by which a servo control, such as track seeking and track following, is executed. Each data sector is reserved for storing data for the end user.

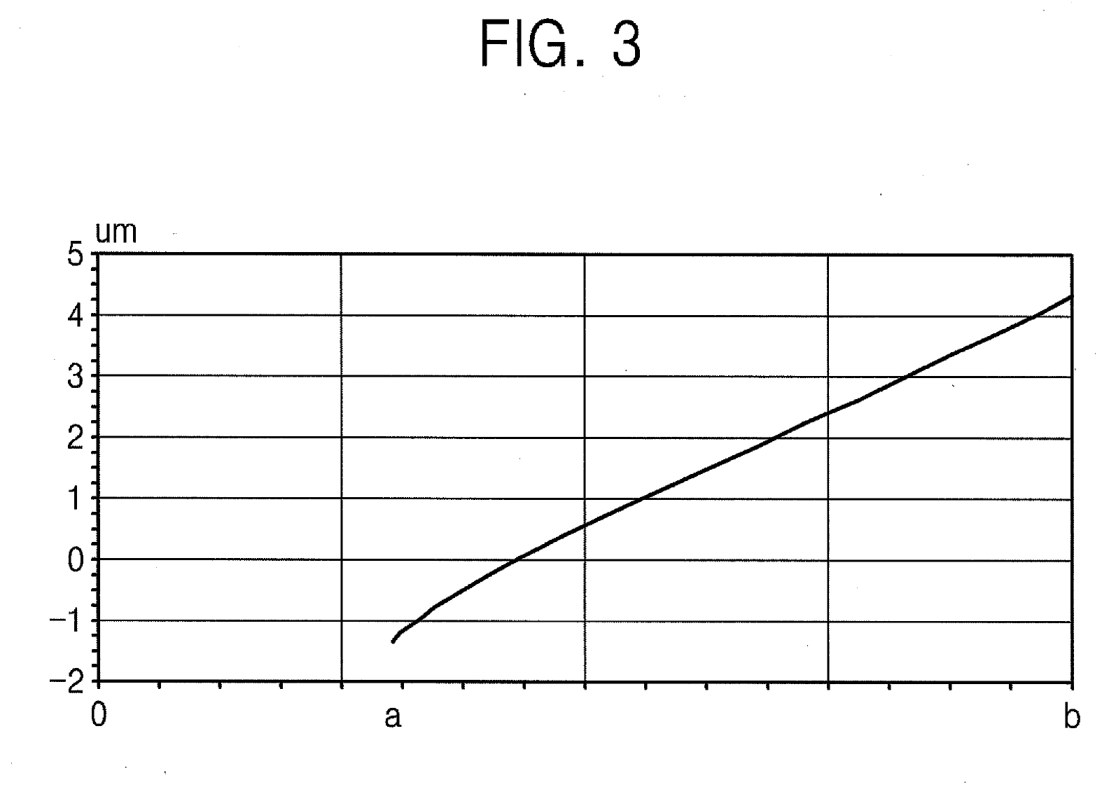

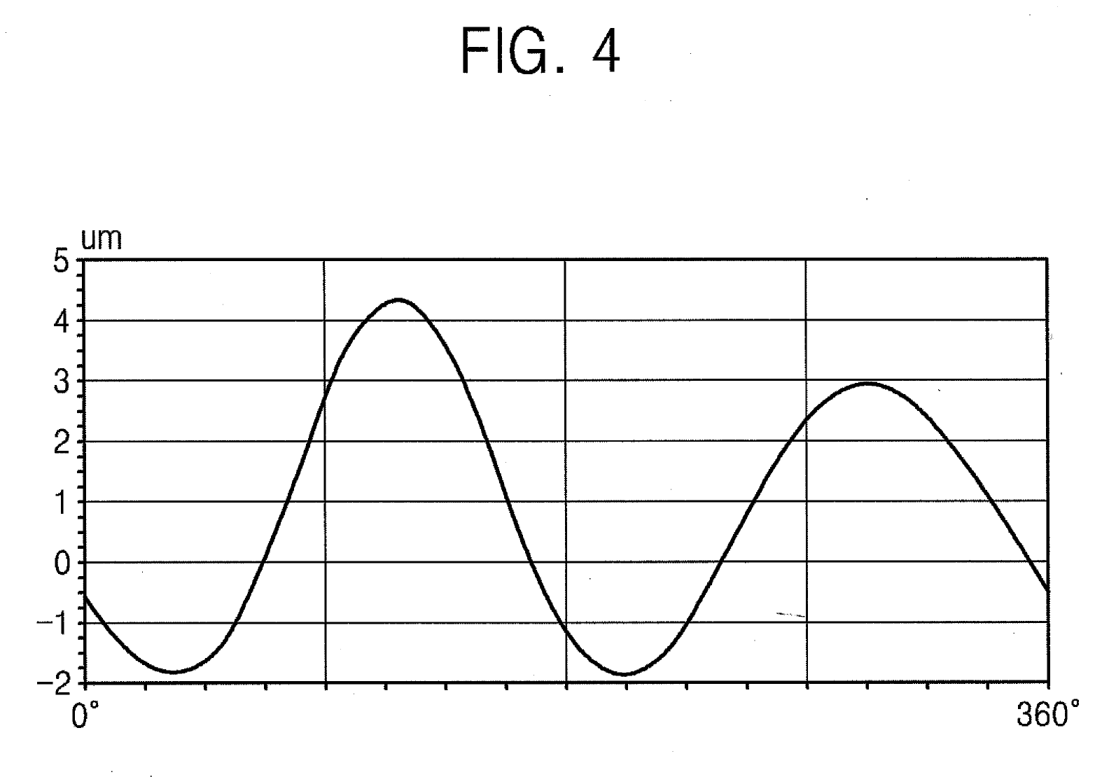

FIG. 3 shows deformation of the disk 111 in the radial direction (indicated by arrow A in FIG. 2), and FIG. 4 shows deformation of the disk 111 in the circumferential direction (indicated by arrow B in FIG. 2). As can be seen from FIG. 3, the recording surface of the disk 111 gradually rises in the radial direction of the disk 111. As can be seen from FIG. 4, the recording surface of the disk 111 undulates (moves up and down) in the circumferential direction. These deformations of the disk 111 may be caused by the clamping torque that fixes the disk 111 to the hub 121 of the SPM 120 and due to errors in the fabricating/assembling of other parts making up the assemblage, e.g., errors that make the surface of the hub 121 uneven relative to the disk 111. These potential problems may be obviated to a degree by improving the shape of the disk clamp 115 and the accuracy of assembly process. However, some deformation of the disk 111 is unavoidable.

The deformation of the disk 111 affects the FH of the magnetic head 131. In particular, the magnetic head 131 vibrates up and down during the rotation of the disk 111 due to deformation of the disk 111 in the circumferential direction. As a result, the FH of the magnetic head 131 decreases to a level below an ideal value especially over portions of the disk where the surface of the disk 111 is high relative to a (reference) plane in which the surface would lie if the disk 111 were not deformed, whereas the FH of the magnetic head 131 increases to a level above the ideal value over portions of the disk 111 where the surface of the disk 111 is low relative to the reference plane. That is, the FH of the magnetic head 131 is changed by the deformation of the disk 111, in particular, by deformation in the circumferential direction. Note, the magnetic head 131 disposed under and confronting the lower surface of the disk 111 experiences substantially similar effects to the magnetic head 131 disposed above the upper surface of the disk 111, but in opposite directions.

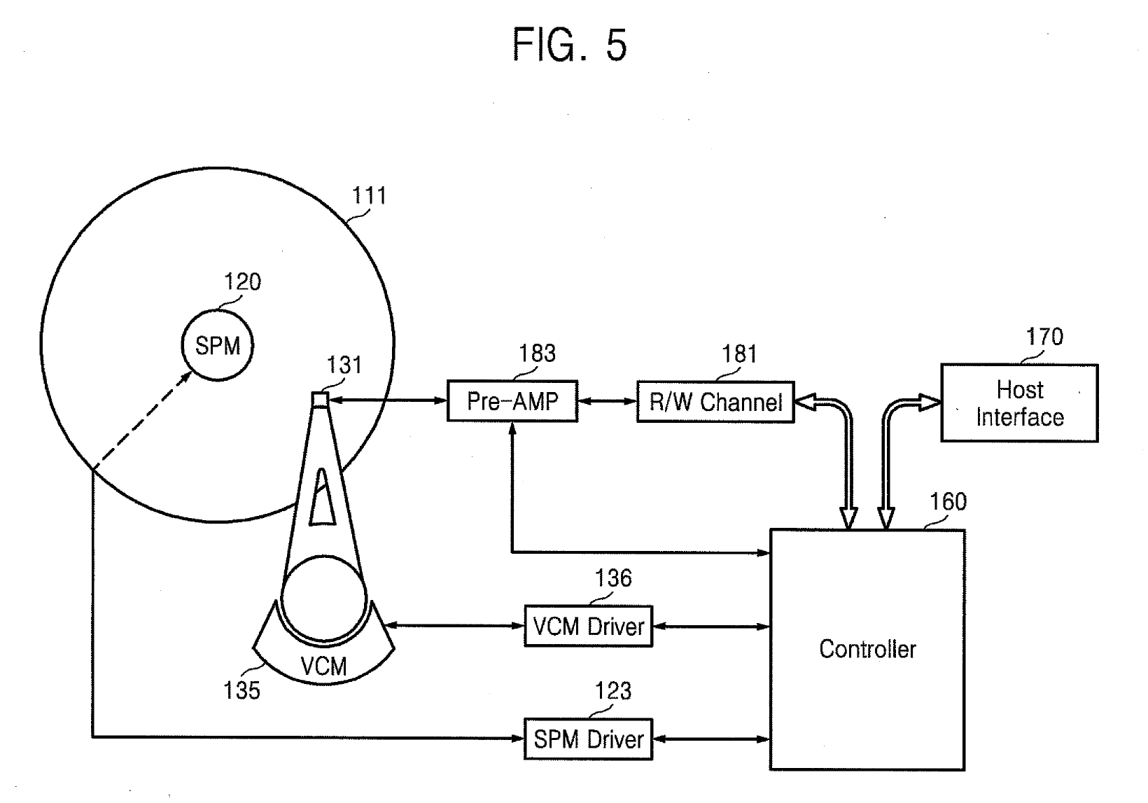

FIG. 5 illustrates a control system of the HDD of FIG. 1. The system includes a controller 160, and a preamplifier (Pre-AMP) 183, a read/write (R/W) channel 181, a host interface 170, a VCM driver 136, and an SPM driver 123 controlled by the controller 160.

The Pre-AMP 183 is connected to the magnetic head 131 and R/W channel 181. During a read operation, the Pre-AMP 183 amplifies a data signal reproduced from the disk 111 by the magnetic head 131 and transmits the amplified data signal to the R/W channel 181. At this time, the R/W channel 181 converts the data signal amplified by the Pre-AMP 183 to a digital signal and transmits the converted signal to a host device (not shown) via the host interface 170. During a write operation, the R/W channel 181 receives data input by a user via the host interface 170, converts the received data to a binary data stream that is easy to write, and inputs the binary data stream to the Pre-AMP 183. The Pre-AMP 183 receives and amplifies the binary data stream from the R/W channel 181, and transmits the amplified binary data stream to the magnetic head 131 so that the data can be written onto the disk.

Thus, the host interface 170 transmits data converted to a digital signal to the host device, and receives user data from the host device and inputs the received data to the R/W channel 181 via the controller 160. The host device may refer collectively to elements, like those of a CPU, for controlling and operating a computer employing an HDD. In this case, the controller 160 serves as an I/O controller of the computer.

In any case, the VCM driver 136 controls, in response to a control signal output from the controller 160, the amount of current supplied to the VCM 135. The SPM driver 123, in response to the control signal of the controller 160, controls the amount of current supplied to the SPM 120. In a data write mode, the controller 160 receives the user data input through the host device via the host interface 170 and outputs the received data to the R/W channel 181. In a data read mode, the controller 160 receives a read signal converted to a digital signal by the R/W channel 181 and outputs the received signal to the host interface 170. Also, the controller 160 controls the output of the VCM driver 136 and the SPM driver 123.

In addition, the controller 160 is configured to control an FOD voltage applied to (a heater of) the magnetic head 131. In this respect, the controller 160 may be a microprocessor or a microcontroller and may be configured by software or firmware.

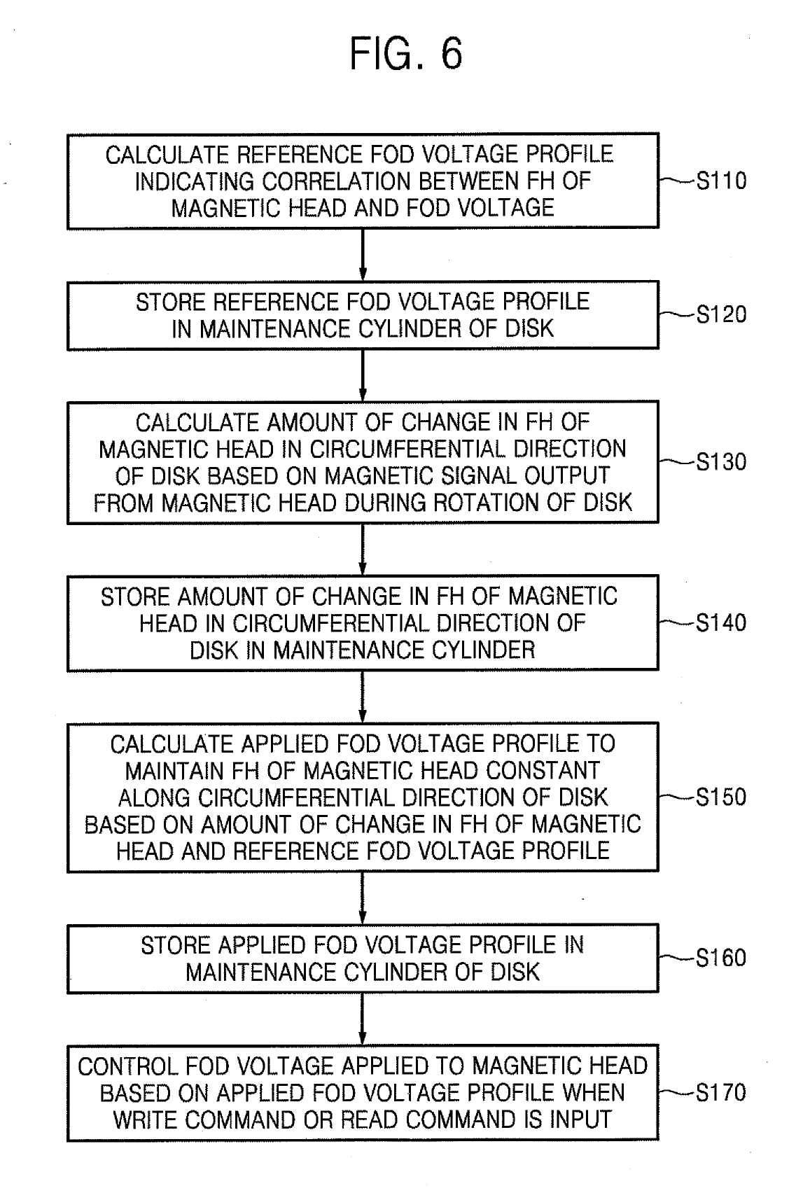

The detailed function of the controller 160 with respect to the controlling of the FOD voltage will be described in detail below. Specifically, a method of controlling an FOD voltage of an HDD according to the present inventive concept will now be described in detail with reference to FIGS. 6-11.

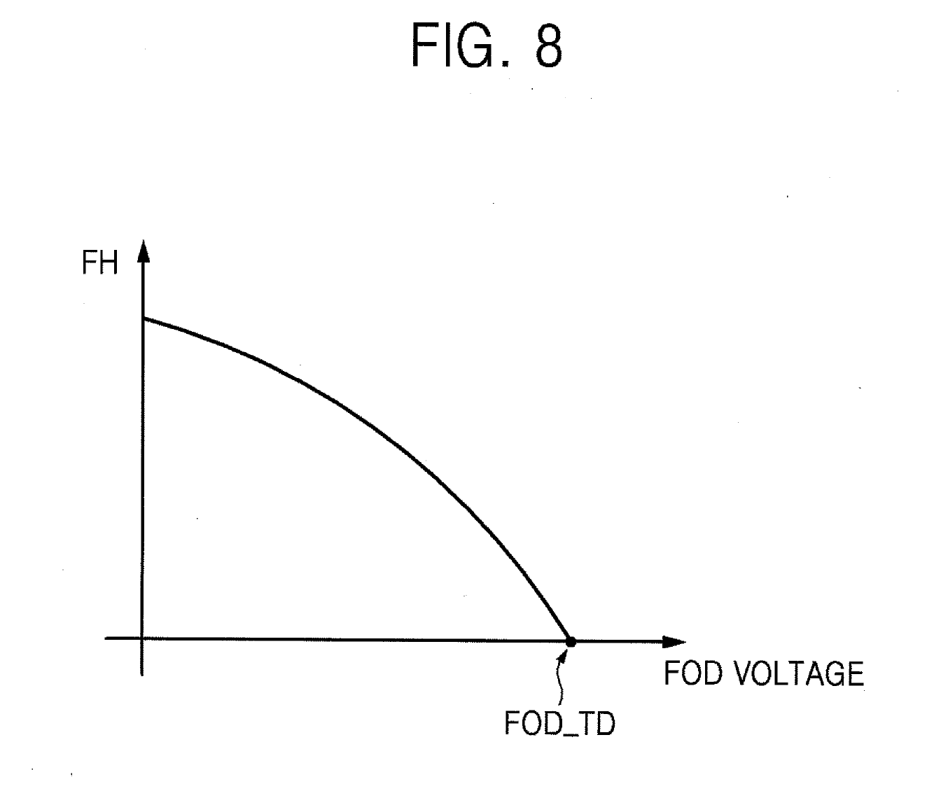

Referring to FIG. 6, first, a reference FOD voltage profile indicating a correlation between the FH of the magnetic head 131 and the FOD voltage (S110) is acquired. The reference FOD voltage profile may be produced during a touchdown test in a burn-in process that is carried out in the manufacturing of the HDD. In this test, an FOD voltage is applied to the magnetic head 131 while the magnetic head 131 is flying at a predetermined height above the disk 111, and the FOD voltage is gradually increased until the magnetic head 131 touches down on the disk 111. FIG. 8 shows the reference FOD voltage profile produced using the touchdown test. The FOD voltage applied to the magnetic head 131 at the time the magnetic head 131 touches down on the disk 111 is referred to as a touchdown FOD (FOD_TD) voltage. Thus, the FH of the magnetic head 131 when the touchdown FOD voltage is applied is 0. The reference FOD voltage profile can be used to determine a profile of applied FOD voltages necessary to produce a target clearance, that is, a target FH, between the magnetic head 131 and the disk 111 in actual use, i.e., in environmental conditions that are prevailing at the time of a read/write operation. The applied FOD voltage profile will be described in more detail later on.

Next, the reference FOD voltage profile is stored in a maintenance cylinder of the disk 111 (S120).

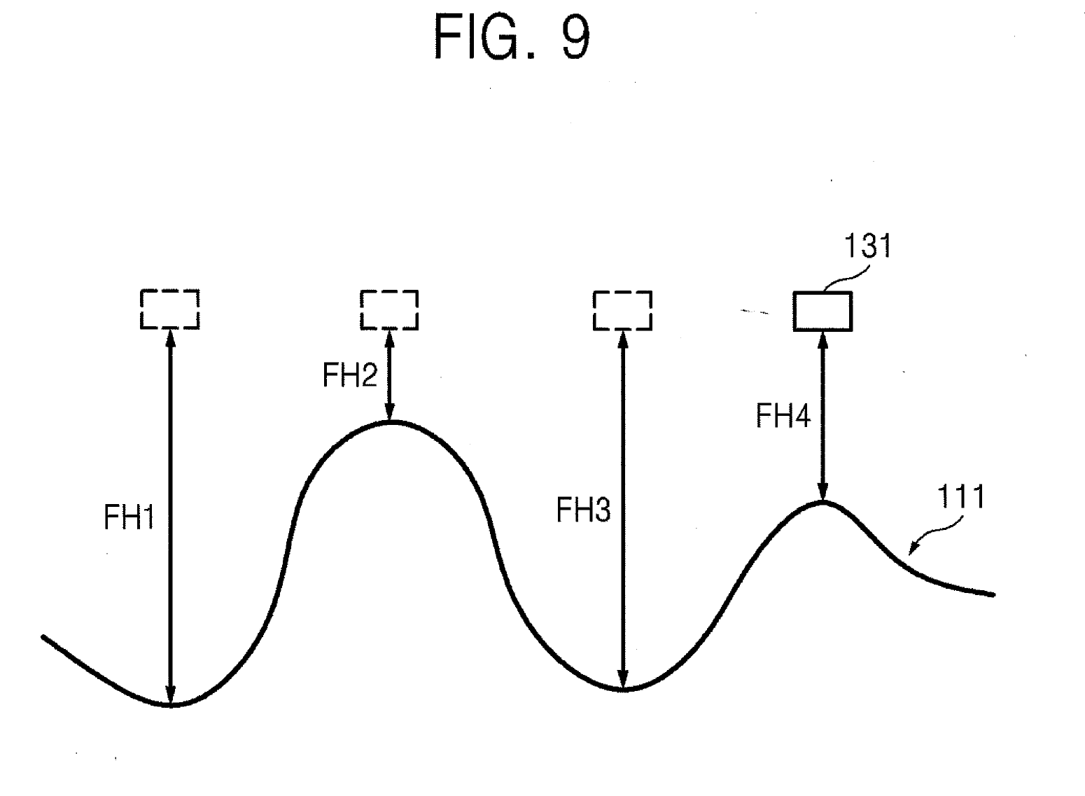

Then, changes in the FH of the magnetic head 131 as a circumferential portion of the disk 111 traverses the head 131 are determined based on the magnetic signal output from the magnetic head 131 during the rotation of the disk 111 (S130). More specifically, in the burn-in process, the disk 111 is rotated a plurality of times, and magnetic signals output from the magnetic head 131 are measured for each rotation of the disk 111. Changes in the FH of the magnetic head 131 at this time are calculated based on the signals output by the magnetic head. As illustrated in FIG. 9, the amplitude of the magnetic signal output from the magnetic head 131 decreases when the flying height FH of the magnetic head 131 increases as relatively low portions of the surface of the disk 111 pass under the magnetic head 131. Thus, in the example shown in FIG. 9, the amplitude of the magnetic signal output from the magnetic head 131 is relatively low when the flying height is FH₁ or FH₃. Also, the amplitude of the magnetic signal output from the magnetic head 131 increases when the flying height FH of the magnetic head 131 decreases, such as occurs when the flying height FH becomes FH₂ or FH₄ in FIG. 9. Thus, the changes in the FH of the magnetic head 131 for each “position” on the disk 11 (that is, for each circumferential portion of the disk that passes by the head 131) may be calculated based on the magnetic signals output by the head 131. As mentioned above, the magnetic signals output from the magnetic head 131 are measured each time the disk 111 makes one complete rotation, and the process may be repeated several times, i.e., the disk 111 makes several complete rotations so that several measurements are taken for each “position” on the disk 111. Changes in the FH of the magnetic head 131 may be calculated based on the signals output by the magnetic head during one or more of such rotations. In the case of the latter, the changes in the FH of the magnetic head 131 may be calculated based on the average of the values of the magnetic signals measured for each position on the disk 111, i.e., based on statistical data.

Furthermore, in the operation (S130) of calculating the changes in the FH of the magnetic head 131, the amplitude of the magnetic signals output from the magnetic head 131 may be measured while a predetermined FOD voltage is applied to the magnetic head. When a predetermined FOD voltage is applied to the magnetic head 131, the FH of the magnetic head 131 is reduced, that is, the gap between the magnetic head 131 and the disk 111 is minimized. Applying the predetermined FOD voltage to the magnetic head while the magnetic signals are output from the magnetic head 131 allows for changes in the FH of the magnetic head to be determined more accurately.

In addition, the operation S130 is performed on at least one track selected for each of the sectioned off regions of the disk 111. For example, a single track is selected for each of the ID region, the MD region, and the OD region of the disk 111 (refer to FIG. 2) and the changes in the FH of the magnetic head 131 are determined for each of the respective selected tracks. The changes in the FH of the magnetic head 131 determined for the selected tracks may be then be interpolated to determine changes in the FH of the magnetic head 131 for other tracks. Also, in this way, changes in the FH of the magnetic head 131 determined for the various tracks, i.e., for circumferential portions of the disk 111, can be analyzed to determine the changes in the FH of the magnetic head 131 for radial portions of the disk. In this regard, changes in the FH of the magnetic head 131 for radial portions of the disk 111 are discerned from the sets of measurements taken in the circumferential direction instead of by moving the head 131 across radially extending portions of the disk 111 because changes in the FH of the magnetic head 131 can be determined more accurately in the circumferential direction than in the radial direction.

In any case, the changes in the FH of the magnetic head 131 for each track of the disk 111, determined in operation S130, are stored in the maintenance cylinder of the disk 111 (S140).

Next (S150), an applied FOD voltage profile is produced based on the reference FOD voltage profile and the changes in the FH of the magnetic head 131 stored in the maintenance cylinder of the disk 111. The applied FOD voltage profile indicates the voltages that must be applied to the (heater of) the magnetic head to maintain the FH of the magnetic head 131 constant given the deformation of the disk 111. In this regard, a respective applied FOD voltage profile may be produced for each track of the disk 111.

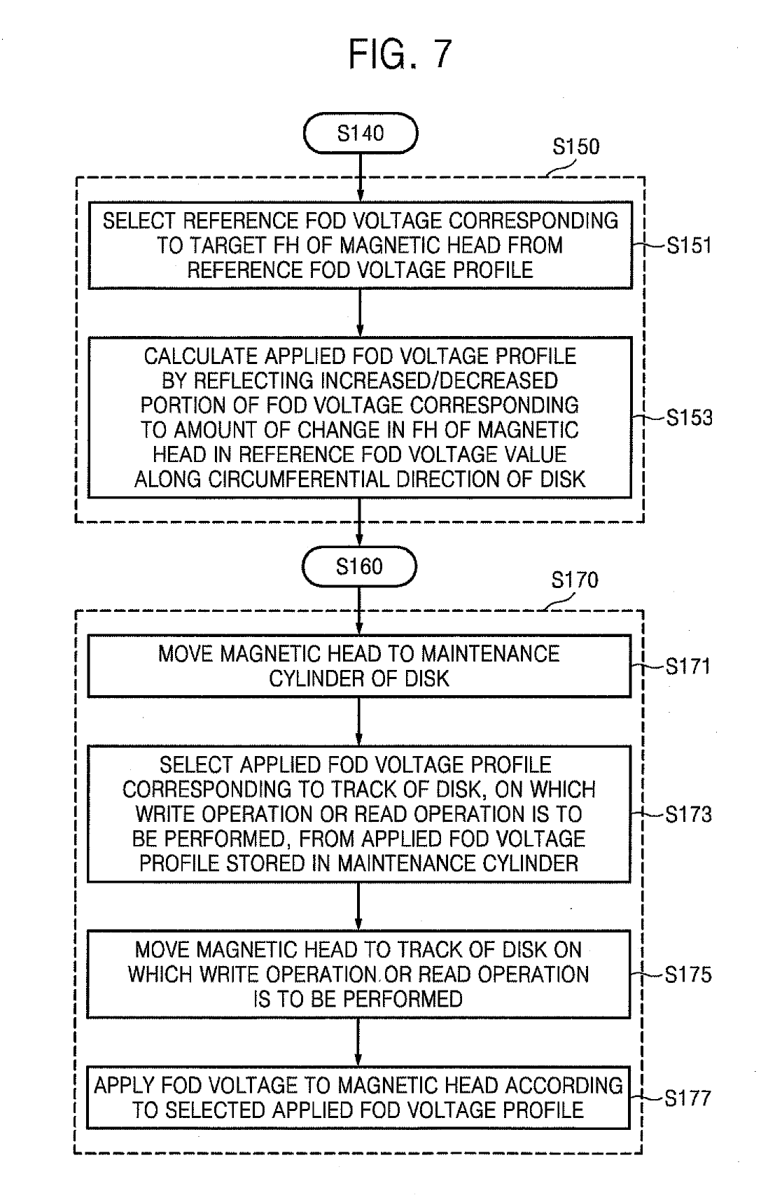

As shown in FIG. 7, the applied FOD voltage profile is produced by selecting a reference FOD voltage corresponding to the target FH of the magnetic head 131 from the reference FOD voltage profile (S151), and reflecting in the selected reference FOD voltage (the value of) an FOD voltage corresponding to the changes in the FH of the magnetic head 131 determined in S130 along the circumferential portion(s) of the disk 111 (S153). Therefore, the values of the FOD voltages which make up the applied FOD voltage profile comprise altered values of the selected reference FOD voltage.

More specifically, in operation S151, the reference FOD voltage signifies the voltage that must be applied to the (heater of) the magnetic head 131 to cause the head to fly at the target FH assuming no deformation in the disk 111. In operation S153, the value of the FOD voltage reflected in the reference FOD voltage corresponds to the amount that the FOD voltage would have to be increased/decreased to effect a change in the FH of the magnetic head 131 corresponding to a change determined in operation S130. This increase or decrease in the FOD voltage can be readily obtained from the reference FOD voltage profile (acquired in S110) that offers a correlation between flying heights (FH) of the magnetic head 131 and the FOD voltages which, if applied, would cause the head 131 to fly at the flying heights (FH) over a non-deformed surface of the disk 111.

The applied FOD voltage profile is obtained for each of the circumferential portions of the disk, e.g. for each of the tracks, referenced above in the description of operation S130. Thus, the applied FOD voltage profile reflects the deformation of the disk 111, particularly in the circumferential direction.

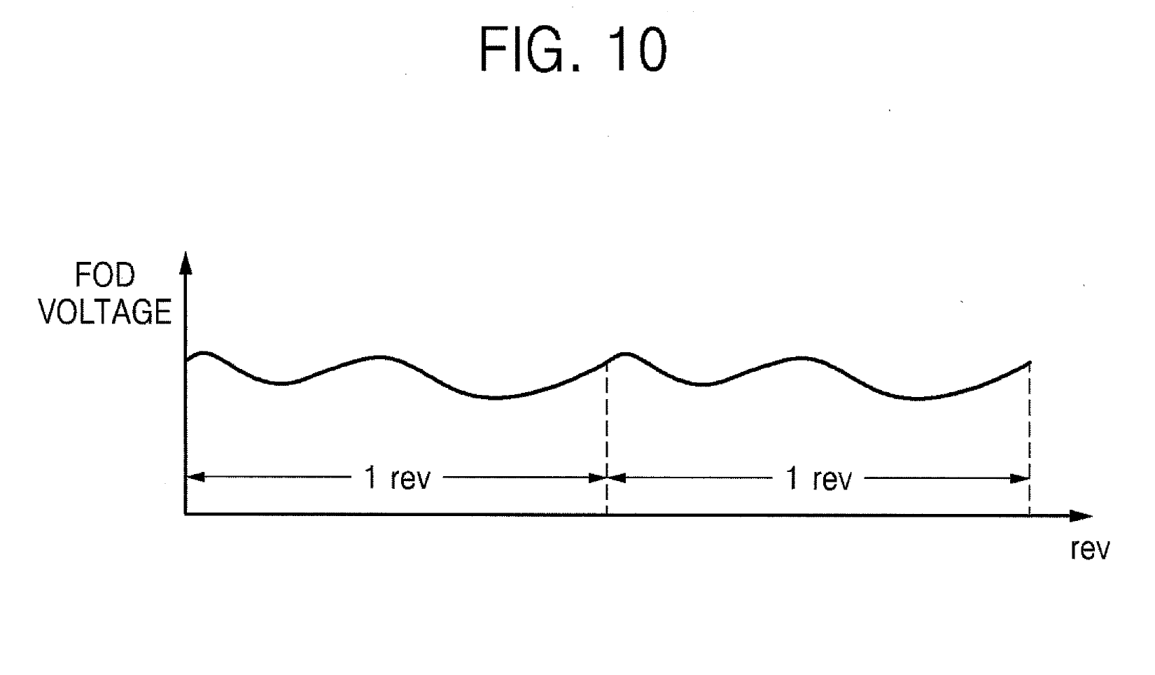

As will be described below, the applied FOD voltage profile is used to determine the amount of FOD voltage that must be actually applied to the magnetic head 131 in a particular environment to maintain the FH of the magnetic head 131 constant while a particular circumferential portion of the disk 111 passes by the head 131 (directly under or directly over the head as the case may be). As illustrated in FIG. 10, the applied FOD voltage profile may thus have an undulating form.

Referring again to FIG. 6, the applied FOD voltage profile is stored in the maintenance cylinder of the disk 111 (S160). Again, in the present embodiment, such an applied FOD voltage profile is produced for each track of the disk 111.

Next, (S170) when a write command or a read command is issued, the FOD voltage applied to the magnetic head 131 is controlled according to the applied FOD voltage profile stored in the maintenance cylinder. The write command is a command to record data (write operation) on a track of the disk 111, and the read command is a command to reproduce data (read operation) from a track.

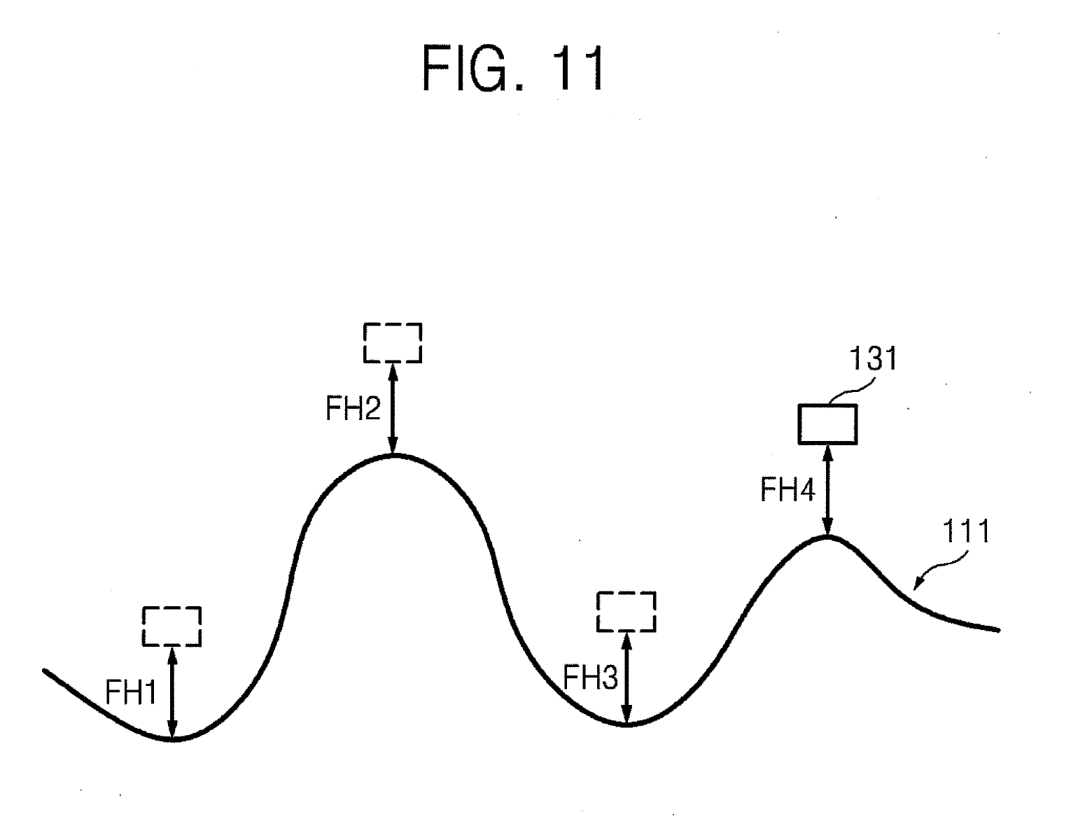

More specifically, as shown in FIG. 7, the magnetic head 131 is moved to the maintenance cylinder when the write command or the read command is issued (S171). An applied FOD voltage profile produced for the target track, i.e., the track at which the write operation or the read operation is to be performed, is selected from the applied FOD voltage profiles stored in the maintenance cylinder (S173). Furthermore, the magnetic head 131 is moved to the target track (S175). An FOD voltage is applied to the magnetic head 131 according to the selected applied FOD voltage profile. When the FOD voltage applied to the magnetic head 131 is controlled according to the applied FOD voltage profile, even if the disk 111 is deformed, especially in the circumferential direction as illustrated in FIG. 11, the FH of the magnetic head 131 is maintained constant along the circumferential direction of the disk 111 (FH₁=FH₂=FH₃=FH₄).

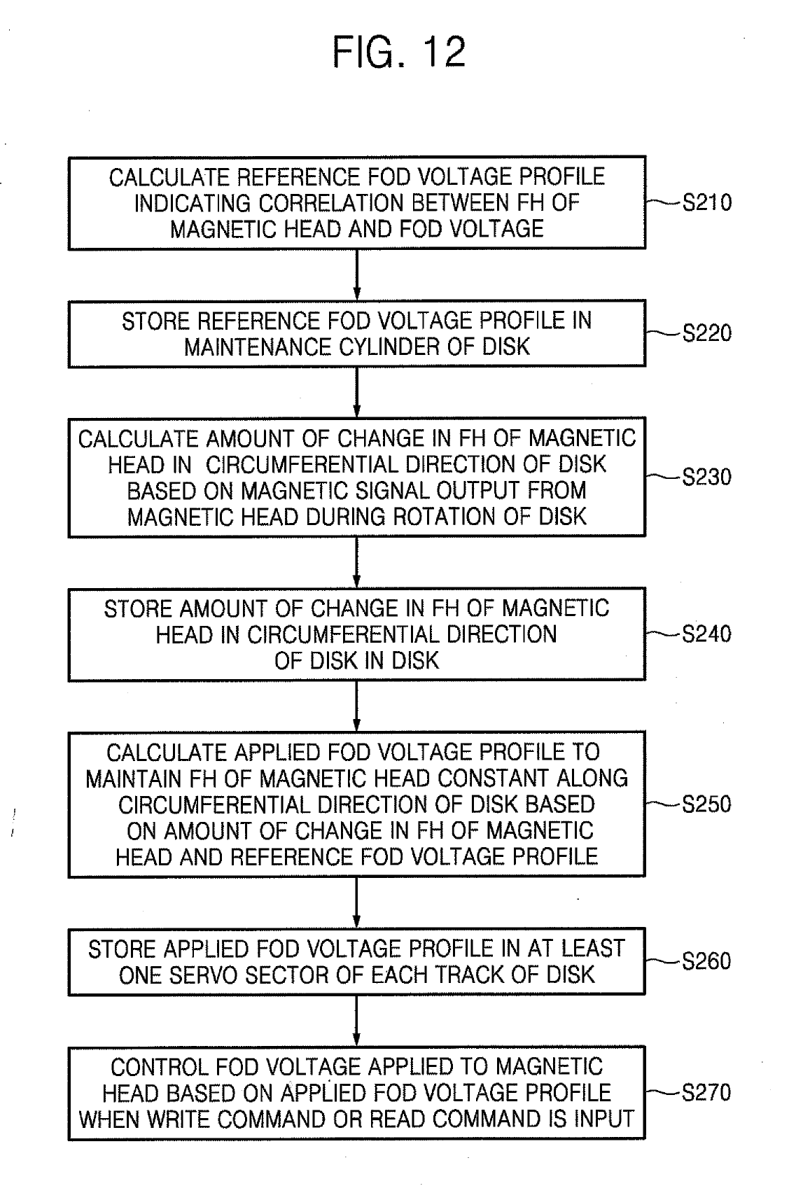

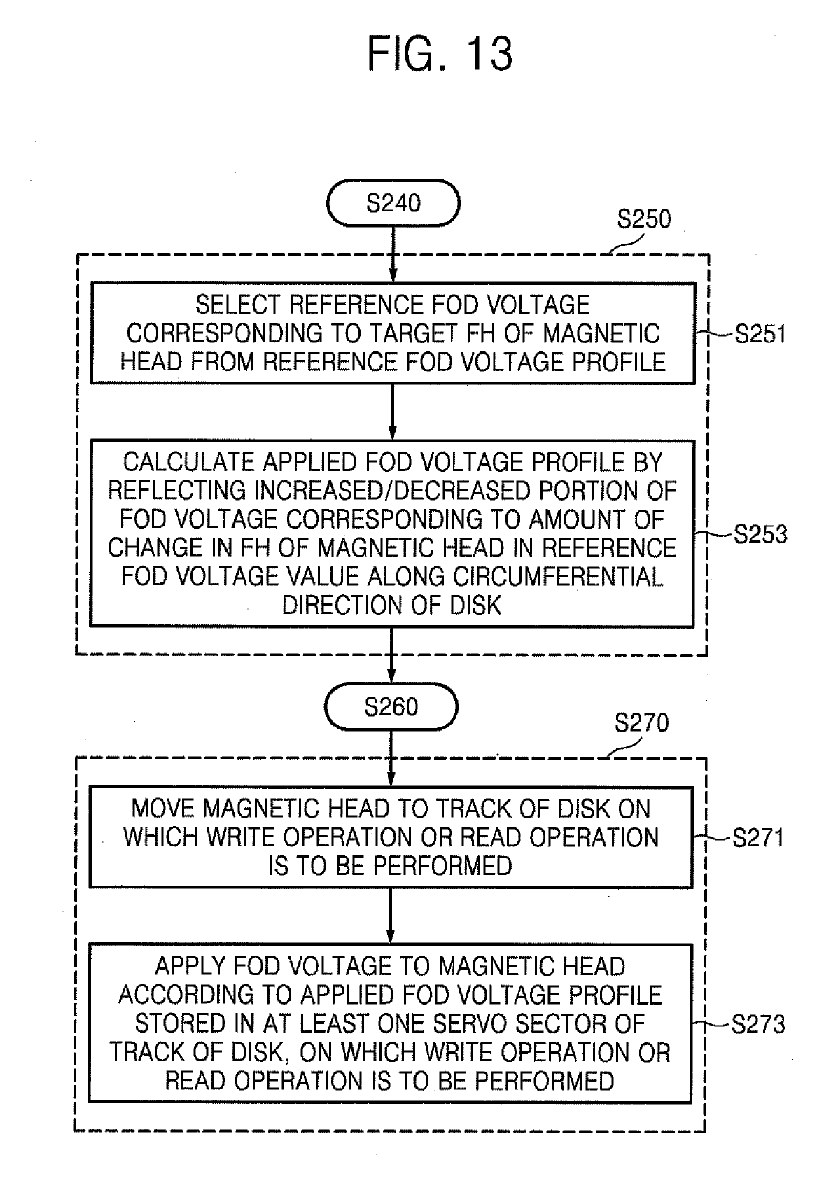

Another method of controlling the FOD voltage of an HDD according to the present inventive concept will be described with reference to FIG. 12 and FIG. 13. Because the method is similar to that described above with reference to FIGS. 6 and 7, mainly the differences between the embodiment of FIGS. 6 and 7 and the embodiment of FIGS. 12 and 13 will be described in detail.

Referring to FIGS. 12 and 13, the method of controlling an HDD according to the inventive concept includes acquiring a reference FOD voltage profile offering a correlation between the FH of the magnetic head 131 and the FOD voltage (S210), storing the reference FOD voltage profile in the maintenance cylinder of the disk 111 (S220), determining changes in the FH of the magnetic head 131 in the circumferential direction of the disk 111 based on the magnetic signals output from the magnetic head 131 during the rotation of the disk 111 (S230), storing the changes in the FH of the magnetic head 131 in the disk 111 (S240), producing an applied FOD voltage profile based on the changes in the FH of the magnetic head 131 and the reference FOD voltage profile (S250), storing the applied FOD voltage profile in at least one servo sector of each track of the disk 111 (S260), and controlling the FOD voltage applied to the magnetic head 131 based on the applied FOD voltage profile when a write command or a read command is input (S270).

As shown in FIG. 13, the applied FOD voltage profile is produced (S250) by selecting a reference FOD voltage corresponding to the target FH of the magnetic head 131 from the reference FOD voltage profile (S251) and by reflecting in the selected reference FOD voltage values of an FOD voltage corresponding to changes in the FH of the magnetic head 131 along the circumferential direction of the disk 111 (S253).

Operations 5210, 5220, 5230, and 5250 outlined above are substantially the same as the operations S110, S120, S130, and S150 described with reference to FIGS. 6 and 7. Therefore, operations 5210, 5220, 5230, and 5250 will not be described in any further detail.

However, in this embodiment, the applied FOD voltage profile is stored in at least one servo sector of each track of the disk 111 (S260). As was described above, servo sectors are alternately disposed with data sectors along the track. In addition, the determined changes in the FH of the magnetic head 131 (S240) may be stored in the maintenance cylinder of the disk 111 as in the above-described embodiment of FIGS. 6 and 7 or in the at least one servo sector of each track of the disk 111.

Referring to FIG. 13, when a write command or a read command is issued, the FOD voltage applied to the magnetic head 131 is controlled (S270) by moving the magnetic head 131 to the target track at which the write operation or read operation is to be performed (S271) and applying an FOD voltage to the magnetic head 131 according to the applied FOD voltage profile stored in the at least one servo sector of the target track.

As described above, according to the method of controlling an HDD according to the present inventive concept, the applied FOD voltage profile corresponding to the deformation of the disk 111 is produced during the burn-in process and when the HDD is in use, the FOD voltage applied to the magnetic head 131 is controlled based on the calculated applied FOD voltage profile. Thus, the FH of the magnetic head 131 can be maintained constant even when the disk 111 is deformed and the deformation varies in the circumferential direction. Accordingly, the method of controlling an HDD according to the present inventive concept can prevent local collisions between the magnetic head 131 and the disk 111, thereby increasing the margin of environments over which the HDD remains reliable. Also, uniformity in the data recording and reproduction along the tracks is improved.

Finally, embodiments of the inventive concept have been described herein in detail. The inventive concept may, however, be embodied in many different forms and should not be construed as being limited to the embodiments described above. Rather, these embodiments were described so that this disclosure is thorough and complete, and fully conveys the inventive concept to those skilled in the art. For example, in the embodiments of the present inventive concept described above, the reference FOD voltage profile, the changes in the FH of the HDD, and the applied FOD voltage profile are stored in the disk 111. However, the inventive concept is not so limited. For example, the reference FOD voltage profile, the changes in the FH of the HDD, and the applied FOD voltage profile may instead be stored in a memory (not shown) of the HDD. Thus, the true spirit and scope of the inventive concept is not limited by the embodiments described above but by the following claims.

What is claimed is:

1. A method of controlling the flying height (FH) of a magnetic head of a hard disk drive (HDD), the method comprising:
determining changes in the FH of a magnetic head of the HDD while a circumferential portion of a disk of the HDD is passing by the magnetic head as the disk is being rotated, by analyzing signals output from the magnetic head;
producing an applied FOD voltage profile based on the changes determined in the FH of the magnetic head and a reference FOD voltage profile, wherein the reference FOD voltage profile offers a correlation between flying heights (FH) of the magnetic head of the HDD and FOD voltages; and
applying an FOD voltage to the magnetic head, and regulating the applied FOD voltage based on the applied FOD voltage profile when a write command or a read command for the HDD is issued.

2. The method of claim 1, wherein the changes in the FH of the magnetic head are determined for at least one track of the disk in each of a plurality of concentric regions of the disk, whereby applied FOD voltage profiles associated with tracks of the disk, respectively, are produced.

3. The method of claim 2, further comprising:
storing, on the disk, data representing the changes in the FH determined for the tracks; and
storing, on the disk, data representing the applied FOD voltage profiles.

4. The method of claim 3, wherein the data representing the changes in the FH is stored in a maintenance cylinder of the disk, and the data representing the applied FOD voltage profiles is also stored in the maintenance cylinder of the disk.

5. The method of claim 4, wherein the regulating of the FOD voltage comprises:
moving the magnetic head to the maintenance cylinder,
selecting from the data stored in the maintenance cylinder, the applied FOD voltage profile associated with a target track of the disk at which a write operation or a read operation is to be performed, and
moving the magnetic head to the target track and regulating the FOD voltage applied to the magnetic head according to the selected applied FOD voltage profile.

6. The method of claim 3, wherein data representing the changes in the FH determined for each track of the disk are stored in a maintenance cylinder of the disk or in at least one servo sector of each track of the disk, and data representing the applied FOD voltage profile associated with each track of the disk is stored in at least one servo sector of the track.

7. The method of claim 6, wherein the regulating of the FOD voltage comprises:
moving the magnetic head to a target track of the disk at which a write operation or a read operation is to be performed, and
regulating the FOD voltage applied to the magnetic head according to the applied FOD voltage profile stored in the at least one servo sector of the target track.

8. The method of claim 1, wherein the applied FOD voltage profile is produced by:
selecting a reference FOD voltage corresponding to a target FH of the magnetic head from the reference FOD voltage profile, and
increasing or decreasing a value of the selected reference FOD voltage by amounts corresponding to the values of FOD voltages which, if applied to the magnetic head, would effect the changes in the FH of the head determined while the circumferential portion of a disk of the HDD passed by the magnetic head.

9. The method of claim 1, further comprising applying a predetermined FOD voltage to the magnetic head while the magnetic signals, used to determine the changes in the FH of the magnetic head, are being output by the magnetic head.

10. The method of claim 1, comprising producing the reference FOD voltage profile during a touchdown test in a burn-in process, and storing data representing the reference FOD voltage profile in a maintenance cylinder of the disk.
